(19) United States
(12) Patent Application Publication
(10) Pub. No.: US 2025/0086982 A1
(43) Pub. Date: Mar. 13, 2025

(54) IMAGING AND DISPLAY SYSTEM FOR MODIFYING COLOR VIDEO STREAM BY DETECTING OBJECTS IN IR VIDEO STREAM

(71) Applicant: Gentex Corporation, Zeeland, MI (US)

(72) Inventors: David M. Falb, Grand Rapids, MI (US); Brian S. Lorence, Washington, MI (US); Brian J. Barksdale, Grand Rapids, MI (US); Brian G. Brackenbury, Grand Haven, MI (US); Bradley A. Bosma, Hudsonville, MI (US); Craig L. Piersma, Wyoming, MI (US)

(21) Appl. No.: 18/828,324

(22) Filed: Sep. 9, 2024

Related U.S. Application Data
(60) Provisional application No. 63/581,483, filed on Sep. 8, 2023.

(51) Int. Cl. G06V 20/58; B60K 35/22; B60K 35/40; G06T 7/70; G06T 19/00; H04N 21/414

(52) U.S. Cl. CPC G06V 20/58; B60K 35/22; B60K 35/40; G06T 7/70; G06T 19/006; H04N 21/41422; G06V 2201/07

(57) ABSTRACT

An imaging and display system is provided for a vehicle having: a video display disposed in an interior of the vehicle; a visible light video camera configured to capture a visible light video stream of an exterior scene in a visible region of the electromagnetic spectrum; a long-range IR video camera configured to capture an IR video stream of the exterior scene in an IR region of the electromagnetic spectrum; and a processing circuit for receiving the visible light video stream and the IR video stream for analyzing the IR video stream to detect an object with reduced visibility in the visible light video stream, and for modifying the visible light video stream by highlighting a region where the detected object should be located in the visible light video stream, the processing circuit configured to supply the modified visible light video stream to the video display for display thereon.

### CROSS-REFERENCE TO RELATED APPLICATION

This application claims priority to and the benefit under 35 U.S.C. § 119 (e) of U.S. Provisional Patent Application No. 63/581,483, filed on Sep. 8, 2023, entitled “IMAGING AND DISPLAY SYSTEM FOR MODIFYING COLOR VIDEO STREAM BY DETECTING OBJECTS IN IR VIDEO STREAM,” by David M. Falb et al., the entire disclosure of which is incorporated herein by reference.

### BACKGROUND OF THE INVENTION

The present invention generally relates to processing of video images streamed to a display, and more specifically to processing of streamed video images of scenes exterior to a vehicle.

### SUMMARY OF THE INVENTION

According to one aspect of the present invention, an imaging and display system is provided for a vehicle including: a video display disposed in an interior of the vehicle; a visible light video camera configured to capture a visible light video stream of an exterior scene in a visible region of the electromagnetic spectrum; a long-range IR video camera configured to capture an IR video stream of the exterior scene in an IR region of the electromagnetic spectrum; and a processing circuit for receiving the visible light video stream and the IR video stream for analyzing the IR video stream to detect an object with reduced visibility in the visible light video stream, and for modifying the visible light video stream by highlighting a region where the detected object should be located in the visible light video stream, the processing circuit configured to supply the modified visible light video stream to the video display for display thereon.

According to another aspect of the present invention, an imaging system is provided for a vehicle including: a video display disposed in an interior of the vehicle; a visible light video camera configured to capture a visible light video stream of an exterior scene in a visible region of the electromagnetic spectrum; a long-range IR video camera configured to capture an IR video stream of the exterior scene in an IR region of the electromagnetic spectrum; and a processing circuit for receiving the visible light video stream and the IR video stream for analyzing the IR video stream to detect an object with reduced visibility in the visible light video stream, and for modifying the visible light video stream by highlighting a region where the detected object should be located in the visible light video stream, the processing circuit configured to supply the modified visible light video stream to the video display for display thereon, wherein the processing circuit modifies the visible light video stream to highlight the detected object by superimposing a graphic symbol at a location where the detected object is located in the corresponding IR video stream.

According to another aspect of the present invention, a method is provided of processing images from a visible light video camera and a long-range IR video camera of a vehicle. The method including: receiving a visible light image frame from the visible light video camera and an IR image frame from the IR video camera; analyzing the IR image frame to detect any objects of interest; when no objects of interest are detected in the IR image frame, supplying the visible light image frame to a video display of the vehicle; when at least one object of interest is detected in the IR image frame, analyzing the visible light image frame to detect if the object is visible; when the at least one object of interest is visible in the visible light image frame, supplying the visible light image frame to the video display; and when the at least one object of interest is not visible in the visible light image frame, modifying the visible light image frame to highlight the detected object and supplying the modified visible light image frame to the video display.

These and other aspects, objects, and features of the present invention will be understood and appreciated by those skilled in the art upon studying the following specification, claims, and appended drawings.

### BRIEF DESCRIPTION OF THE DRAWINGS

The patent or application file contains at least one drawing executed in color. Copies of this patent or patent application publication with color drawings will be provided by the Office upon request and payment of the necessary fee. In the drawings:

FIG. 1A is a photographic representation of an example of an image frame from a visible light video stream taken of a scene in dark conditions;

FIG. 1B is a photographic representation of an example of an image frame from an IR video stream taken of the same scene in FIG. 1A also in dark conditions;

FIG. 2 is a block diagram of an imaging system according to an embodiment of the invention;

FIG. 3A is a photographic representation of an example of an image frame from an IR video stream;

FIG. 3B is a photographic representation of an example of an image frame from a modified visible light video stream that may be generated by the processing circuit shown in FIG. 2;

FIG. 4A is a photographic representation of another example of an image frame from an IR video stream;

FIG. 4B is a photographic representation of another example of an image frame from a modified visible light video stream that may be generated by the processing circuit shown in FIG. 2;

FIG. 5A is a photographic representation of yet another example of an image frame from an IR video stream;

FIG. 5B is a photographic representation of yet another example of an image frame from a modified visible light video stream that may be generated by the processing circuit shown in FIG. 2;

FIG. 6 is a flow chart showing the method steps performed by the processing circuit shown in FIG. 2;

FIG. 7A is a front and side perspective view of a rearview assembly incorporating the imaging system of FIG. 2; and

FIG. 7B is a front elevational view of the rearview assembly shown in FIG. 7A.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily of a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

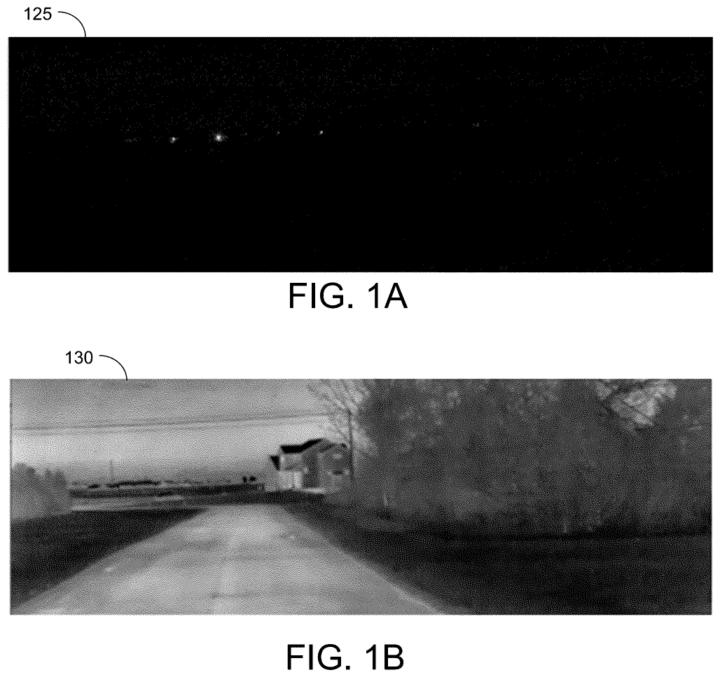

It has become commonplace to provide cameras in a vehicle to capture images or video streams of scenes exterior of the vehicle in order to detect objects and/or display the captured images/video streams to the driver. Current color video cameras provide high resolution video with excellent color reproduction in well illuminated scenes but struggle to provide usable video in dark conditions. FIG. 1A shows an example of an image frame of a visible light video stream 125 of a scene captured in dark conditions. Conversely, long range infrared (IR) video cameras can provide video in full darkness, but this video is at a lower resolution, is greyscale, and is not “natural” in appearance. FIG. 1B shows an example of an image frame of an IR video stream 130 of a corresponding scene captured in dark conditions. Since long range IR cameras sense thermal energy, they are capable of clearly imaging “living” objects (people, animals) in complete darkness. Accordingly, such long-range IR cameras have also been implemented in vehicles. The embodiments described below combine the strengths of each camera technology into a single video stream that may be displayed on a display.

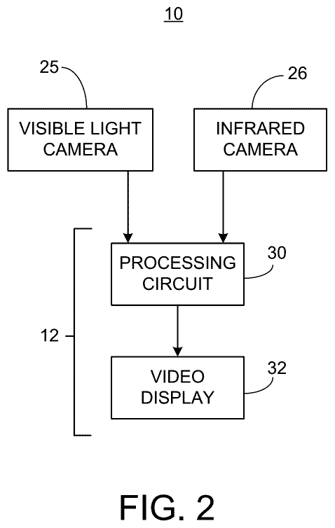

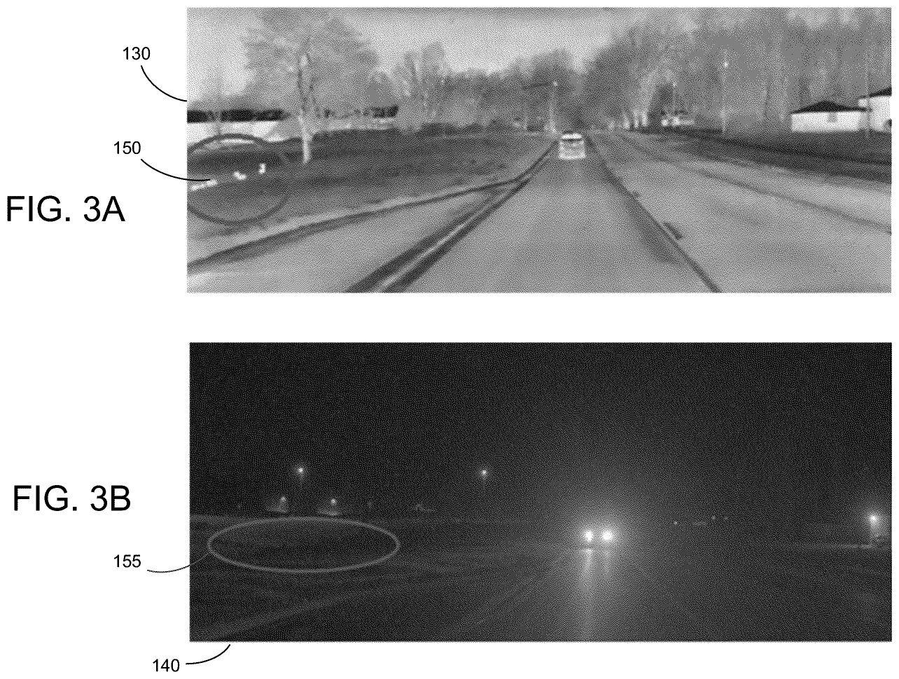

FIG. 2 shows an imaging and display system 10 according to a first embodiment. As shown, imaging and display system 10 includes a visible light video camera 25 for generating a visible light video stream 125 (FIG. 1A) of a scene exterior of the vehicle, a long-range infrared (IR) video camera 26 for generating an IR video stream 130 (FIG. 1B and 3A) of the same exterior scene, and a display system 12. The display system 12 includes a processing circuit 30 that generates a modified visible light video stream 140 (as discussed in detail below and shown in FIG. 3B) and a display 32 that displays the modified visible light video stream 140. The two video cameras 25 and 26 have at least overlapping fields of view, and preferably, the same field of view. The visible light video camera 25 may be a color camera such as a CMOS color video camera producing a RGGB, RCCB, RCCG or RYYCy video stream.

The processing circuit 30 receives the streamed video images for analyzing the IR video stream 130 to detect an object with reduced visibility in the visible light video stream 125, and for modifying the visible light video stream 125 by highlighting a region where the detected object should be located in the visible light video stream 125. The processing circuit 30 is configured to supply the modified visible light video stream 140 to the video display 32 for display thereon. More specifically, as shown in FIG. 3A, the processing circuit 30 analyzes the image frames of the IR video stream 130 to detect any objects 150 (e.g., deer in FIG. 3A) that may not be very visible in the visible light video stream as a result of darkness, rain, snow, fog, or lens flare from direct sunlight. Because long-range IR cameras 26 are very good at imaging live objects, such as humans and animals, the processing circuit 30 may use robust detection algorithms. Once the processing circuit 30 detects any objects, the processing circuit 30 modifies the visible light video stream as shown in FIG. 3B by superimposing a graphic symbol or icon 155 or the like in order to highlight the region of the visible light video stream where the objects 150 should be located. The modified visible light video stream 140 is then supplied to the video display 32 for display thereon. As an alternative for using a graphic icon for the highlight, the processing circuit 30 may highlight the region with a box, a circle, an ellipse, or a color highlight.

The processing circuit 30 may optionally classify any detected objects and then overlay an icon or symbol corresponding to the classified object. For example, using augmented reality, the processing circuit 30 may classify the object as a human, dog, or deer and then overlay an icon of a human, dog, or deer on the visible light video stream in the location where the human, dog, or deer should be located in the visible light video stream.

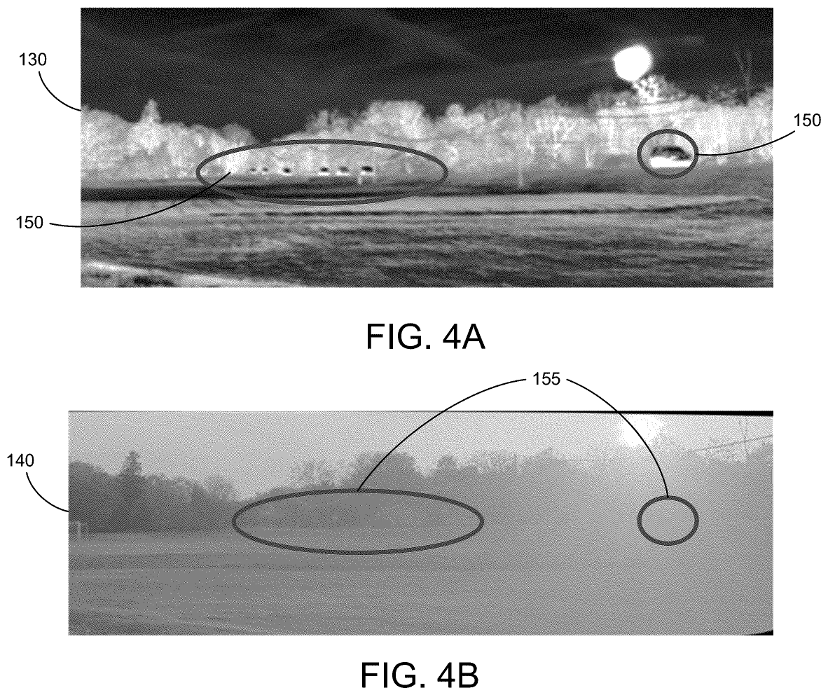

FIGS. 4A and 4B show an example where lens flare from the sun may obscure objects of interest (e.g., vehicles) 150 that are only clearly visible in the IR video stream 130. Object recognition software executed by the processing circuit 30 analyzes image frames in the IR video stream 130 to detect moving objects, such as vehicles, as apparent from FIG. 4A. The processing circuit 30 may then modify the visible light video stream by superimposing graphics 155 to warn the driver of obscured objects in the identified regions of the modified visible light video stream 140.

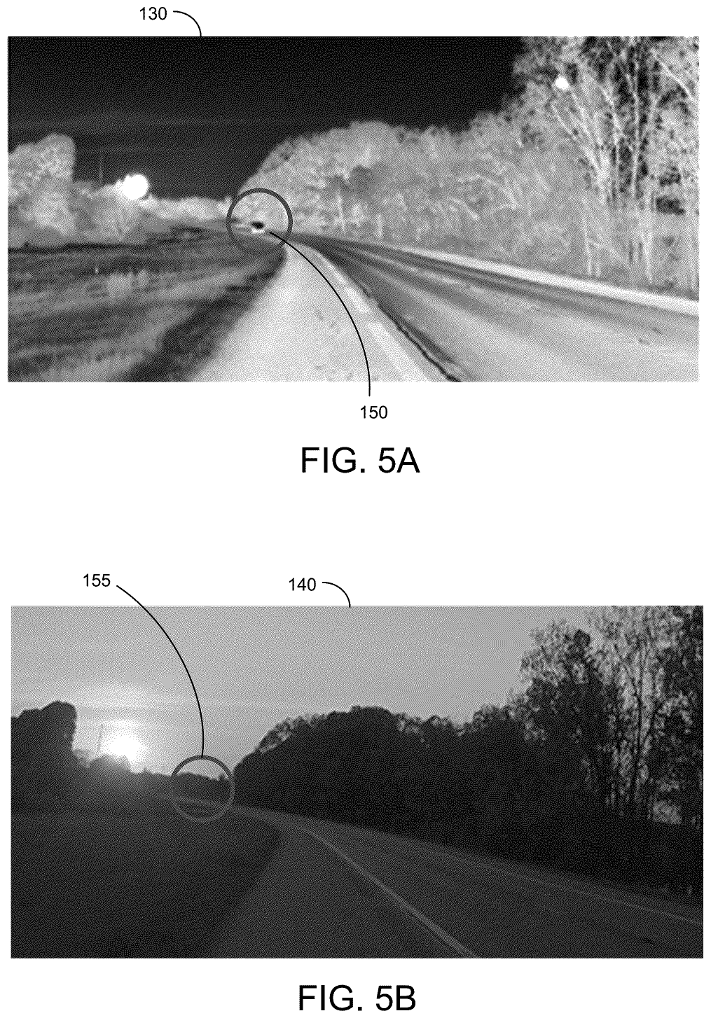

FIGS. 5A and 5B illustrate yet another example wherein an object of interest 150 is detected in the IR video stream 130 (FIG. 5A) so that the processing circuit 30 may generate a modified visible light video stream 140 showing the region where the object should be located using a superimposed graphic 155. In this example, the object 150 is a moving vehicle that is within a low contrast region of the visible light video stream.

It should be noted that the video cameras 25 and 26 may be mounted so as to capture video streams 125 and 130 of a forward exterior scene, a rearward exterior scene, or a side exterior scene relative to the vehicle's direction of travel.

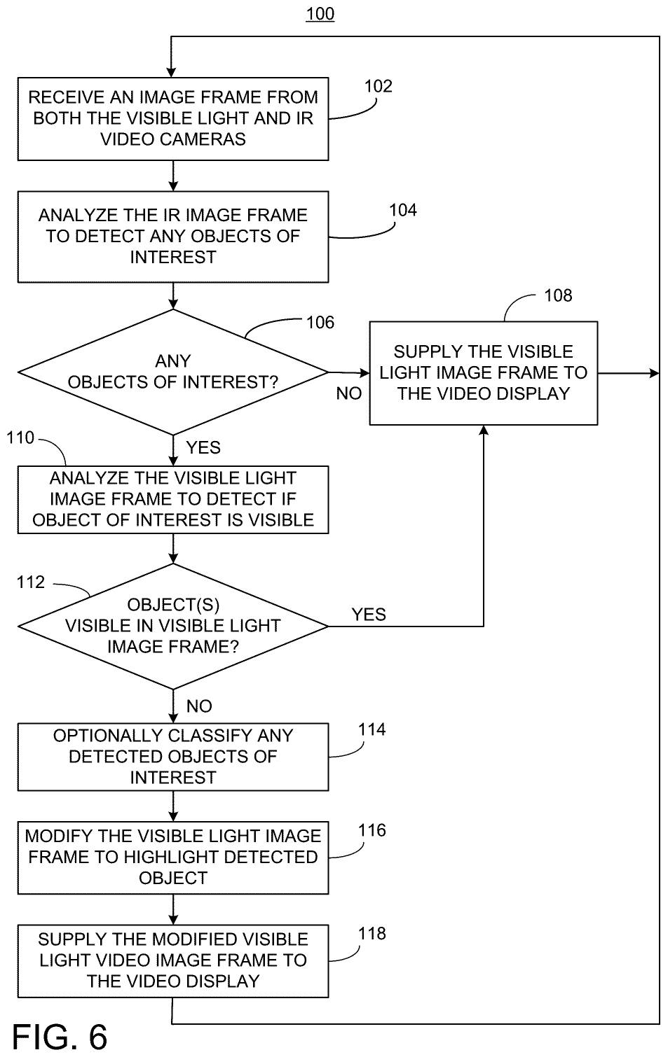

FIG. 6 is a flowchart showing the steps of a method 100 performed by the processing circuit 30. In step 102, the processing circuit 30 receives an image frame of the visible light video stream 125 from the visible light video camera 25 and a corresponding image frame of the IR video stream 130 from the IR video camera 26. Then, in step 104, the processing circuit 30 analyzes the IR image frame to detect any objects of interest (living objects, moving objects, street signs, or lane markings). Next, the processing circuit 30 determines whether there are any objects of interest in the IR image frame in step 106. If there are no objects detected, the processing circuit 30 supplies the visible light image frame to the video display 32. Steps 102-108 are repeated for each image frame of the captured video streams 125 and 130 so that that visible light video stream 125 is displayed in an unmodified form (step 108).

If an object of interest is detected per step 106, the processing circuit 30 then may analyze the visible light image frame to detect if the object is sufficiently visible that no modification is needed (step 110). If the processing circuit 30 determines in step 112 that the object(s) are sufficiently visible, the processing circuit 30 supplies the visible light image frame to the video display (step 108). Steps 102-108 are repeated for each image frame of the captured video streams 125 and 130 so that the visible light video stream 125 is displayed in an unmodified form (step 108). Sufficient visibility may occur when there is sufficient contrast of the object with its immediate surroundings.

If an object of interest that is detected in the IR image frame is not sufficiently visible in the visible light image frame, the processing circuit 30 may then optionally classify the detected object in step 114. The processing circuit 30 will then modify the visible light image frame by highlighting the region in the visible light image frame where the obscured object should be located in step 116. The processing circuit 30 then supplies the modified visible light image frame to the video display 32. So long as an object of interest is detected in the IR image frames and not visible in the visible light image frames, steps 102-106 and 110-118 are repeated to thereby generate and display a modified visible light video stream 140 from the sequential modified visible light image frames. If the object of interest is classified in step 114 in one or more classes of objects such as moving objects, living objects, street signs, or lane markings, the processing circuit 30 may optionally perform the modification in step 116, but may skip the modification if the detected object of interest falls outside those object classifications. As noted above, the object classifications may additionally or alternatively be used to select which graphic symbol to superimpose on the visible light image frame.

The processing circuit 30 may include various types of image processing circuitry, digital and/or analog, and may include a microprocessor, microcontroller, application-specific integrated circuit (ASIC), graphics processing unit (GPU), or other circuitry configured to perform various input/output, control, analysis, and other functions to be described herein. In other embodiments, the image processor 30 may be a system on a chip (SoC) individually or with additional hardware components described herein.

The display system 12 may be provided anywhere within the interior of a vehicle, particularly the processing circuit 30. The video display 32 may be located where it is visible to the driver such as in the instrument panel, center console, rearview assembly, or may be implemented as a heads-up or projected display.

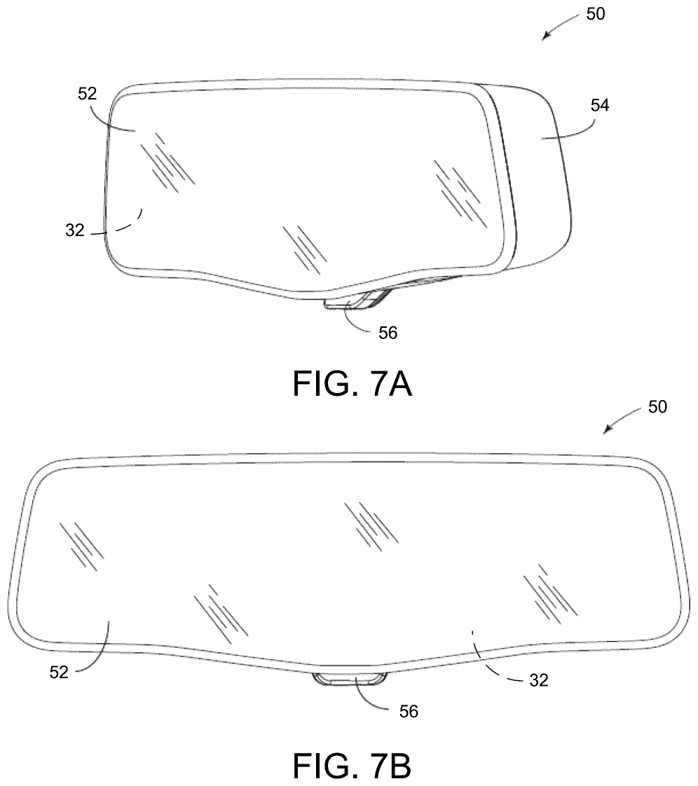

FIG. 7A is a front and side perspective view of a rearview assembly 50 incorporating the imaging and display system 10 of FIG. 2, and FIG. 7B is a front elevational view of the rearview assembly 50. The rearview assembly 50 includes a housing 54 and a transparent or semi-transparent element 52 extending across an opening in the housing 54. The display 32 is provided behind the transparent or semi-transparent element 52 so as to project the displayed composite video stream 120 therethrough when the display 32 is active. The display 32 may be activated in response to a toggle switch 56.

The transparent or semi-transparent element 52 may be a partially reflective, partially transmissive mirror element or a switchable reflective element. Examples of a switchable reflective element are disclosed in commonly-assigned U.S. Pat. Nos. 9,254,789; 9,637,054; and 9,834,146, the entire disclosures of which are hereby incorporated herein by reference. Examples of partially reflective, partially transmissive mirror elements positioned in front of a display are disclosed in commonly-assigned U.S. Pat. No. 10,705,332, the entire disclosure of which is incorporated herein by reference.

In the event the display 32 is incorporated as a full display mirror (FDM) of the rearview assembly 50, which may typically display a rearward video stream, and a forward-facing long-range IR camera 26 is utilized for detection of objects specifically in situations of low visibility in the visible spectrum, this detection could then be displayed in the top region of the display 32 as it would be a more prominent location to alert the driver. The location and threat level could be indicated at the top of the display 32 in a simple way by varying the location and size horizontally to indicate the location and size of the forward object and use of color (red, yellow, green) to indicate the threat level (time to impact).

Although the above description mentions the display of either a modified or unmodified version of the visible light video stream, a composite video stream generated by superimposing some or all of the IR video stream 130 over the visible light video stream 130 may be possible. The graphic 155 may then be superimposed on the composite video stream. Alternatively, the regions of the IR video stream 130 in which the detected objects are located or images of the detected objects themselves may be superimposed on the visible light video stream in order to increase the visibility of those objects.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. An imaging and display system for a vehicle, comprising:
a video display disposed in an interior of the vehicle;
a visible light video camera configured to capture a visible light video stream of an exterior scene in a visible region of the electromagnetic spectrum;
a long-range IR video camera configured to capture an IR video stream of the exterior scene in an IR region of the electromagnetic spectrum; and
a processing circuit for receiving the visible light video stream and the IR video stream for analyzing the IR video stream to detect an object with reduced visibility in the visible light video stream, and for modifying the visible light video stream by highlighting a region where the detected object should be located in the visible light video stream, the processing circuit configured to supply the modified visible light video stream to the video display for display thereon.

2. The imaging and display system of claim 1, wherein the detected object is a living object.

3. The imaging and display system of claim 1, wherein the detected object is a moving object.

4. The imaging and display system of claim 1, wherein the detected object is at least one of a street sign and a lane marker.

5. The imaging and display system of claim 1, wherein the visible light video camera is a color video camera and the visible light video stream is in color.

6. The imaging and display system of claim 1, wherein the processing circuit classifies the detected object.

7. The imaging and display system of claim 6, wherein the processing circuit modifies the visible light video stream to highlight the detected object when the at least one object of interest is classified into specific classifications, and wherein the processing circuit does not modify the visible light video stream when the detected object when the at least one object of interest is not classified into specific classifications.

8. The imaging and display system of claim 6, wherein the processing circuit modifies the visible light video stream to highlight the detected object by superimposing a graphic symbol at a location where the detected object is located in the corresponding IR video stream, and the graphic symbol is selected based on the classification of the detected object.

9. The imaging and display system of claim 1, wherein the processing circuit modifies the visible light video stream to highlight the detected object by superimposing a graphic symbol at a location where the detected object is located in the corresponding IR video stream.

10. An imaging system for a vehicle, comprising:
a video display disposed in an interior of the vehicle;
a visible light video camera configured to capture a visible light video stream of an exterior scene in a visible region of the electromagnetic spectrum;
a long-range IR video camera configured to capture an IR video stream of the exterior scene in an IR region of the electromagnetic spectrum; and
a processing circuit for receiving the visible light video stream and the IR video stream for analyzing the IR video stream to detect an object with reduced visibility in the visible light video stream, and for modifying the visible light video stream by highlighting a region where the detected object should be located in the visible light video stream, the processing circuit configured to supply the modified visible light video stream to the video display for display thereon, wherein the processing circuit modifies the visible light video stream to highlight the detected object by superimposing a graphic symbol at a location where the detected object is located in the corresponding IR video stream.

11. The imaging system of claim 10, wherein the detected object is at least one of a living object, a moving object, a street sign, and a lane marker.

12. The imaging system of claim 10, wherein the visible light video camera is a color video camera and the visible light video stream is in color.

13. The imaging system of claim 10, wherein the processing circuit classifies the detected object.

14. The imaging system of claim 13, wherein the processing circuit modifies the visible light video stream to highlight the detected object when the at least one object of interest is classified into specific classifications, and wherein the processing circuit does not modify the visible light video stream when the detected object when the at least one object of interest is not classified into specific classifications.

15. The imaging system of claim 13, wherein the graphic symbol is selected based on the classification of the detected object.

16. A method of processing images from a visible light video camera and a long-range IR video camera of a vehicle, the method comprising:
receiving a visible light image frame from the visible light video camera and an IR image frame from the IR video camera;
analyzing the IR image frame to detect any objects of interest;
when no objects of interest are detected in the IR image frame, supplying the visible light image frame to a video display of the vehicle;
when at least one object of interest is detected in the IR image frame, analyzing the visible light image frame to detect if the object is visible;
when the at least one object of interest is visible in the visible light image frame, supplying the visible light image frame to the video display; and
when the at least one object of interest is not visible in the visible light image frame, modifying the visible light image frame to highlight the detected object and supplying the modified visible light image frame to the video display.

17. The method of claim 16 and further comprising classifying the at least one object of interest detected in the IR image frame.

18. The method of claim 17 and further comprising performing the step of modifying the visible light image frame to highlight the detected object when the at least one object of interest is classified into specific classifications, and not performing the step of modifying the visible light image frame when the detected object when the at least one object of interest is not classified into specific classifications.

19. The method of claim 17, wherein the visible light image frame is modified to highlight the detected object by superimposing a graphic symbol at a location where the detected object is located in the corresponding IR image frame, and the graphic symbol is selected based on the classification of the detected object.

20. The method of claim 16, wherein the visible light image frame is modified to highlight the detected object by superimposing a graphic symbol at a location where the detected object is located in the corresponding IR image frame.
